(19) United States
(12) Patent Application Publication
(10) Pub. No.: US 2013/0025433 A1
(43) Pub. Date: Jan. 31, 2013

(54) CRADLE FOR HOLDING TWO DRUMSTICKS TOGETHER

(71) Applicant: Robert P. Gatti, Hoffman Estates, IL (US)

(72) Inventor: Robert P. Gatti, Hoffman Estates, IL (US)

(21) Appl. No.: 13/561,059

(22) Filed: Jul. 29, 2012

Related U.S. Application Data
(60) Provisional application No. 61/513,393, filed on Jul. 29, 2011.

(51) Int. Cl. G10D 13/02

(52) U.S. Cl. 84/422.4

(57) ABSTRACT

A two-channeled cradle securely holds two drumsticks together to enhance organization and portability while preventing loss among other sticks. The cradle also prohibits drumsticks from rolling off a drum or any flat surface. The cradle can include two channels, side-by-side, formed in a C-shape with a diameter slightly less than that of the drumsticks, where the drumsticks can snap into the channels. In some embodiments, the cradle can be formed of two circular channels, where the drumsticks can be inserted into the channels. The cradle can have a flat bottom to help keep the cradle in place, without rolling or wobbling. By using the cradle, a drummer can reach into their stick bag and easily pull out a matched pair of drumsticks.

### CROSS-REFERENCE TO RELATED APPLICATION

This application claims the benefit of priority of U.S. provisional application number 61/513,393, filed Jul. 29, 2011, the contents of which are herein incorporated by reference.

### BACKGROUND OF THE INVENTION

The present invention relates to drumming accessories and, more particularly, to a two-channeled cradle that securely holds two drumsticks together to enhance organization and portability.

When drummers purchase a pair of drumsticks and dispose of the cardboard sleeve that contains the two sticks, they no longer have a viable way to contain the sticks when they are either being held while not playing, while in their back pocket, or when placed in a stick bag with other sticks and accessories.

Many drummers carry multiple sticks for playing music, often in a single stick bag. The drummer may have thinner sticks, such as size 7a sticks, for playing a softer piece, larger sticks, such as size 2b sticks, for playing more loudly. The drummer may also have well-worn sticks used for playing pieces with rim shots, and the like. Between pieces, the drummer may need to reach for and quickly retrieve a different set of sticks. If they have more than two pair, that often involves reaching for the sticks and matching the appropriate sticks from a plurality of different sticks. This is often required to be done by the drummer in minimal light.

As can be seen, there is a need for a device that can keep a matched pair of sticks together and identifiable to enhance organization and portability.

### SUMMARY OF THE INVENTION

In one aspect of the present invention, a drumstick cradle comprises a cradle body having a flat base; a first channel disposed adjacent to a second channel in the cradle body; and a center rib separating the first channel from the second channel, wherein the first channel and the second channel are operable to securely hold a pair of drumsticks therein.

In another aspect of the present invention, a drumstick cradle comprises a cradle body having a flat base; a first channel disposed adjacent to a second channel in the cradle body, the first channel and the second channel are formed in a semi-circular shape to permit the pair of drumsticks to be pressed into the first and second channels, the semi-circular shape extending about 200 to about 290 degrees of a full circle; and a center rib separating the first channel from the second channel, wherein the first channel and the second channel are operable to securely hold a pair of drumsticks therein.

In a further aspect of the present invention, a drumstick holder comprises a holder body having a flat base; a first channel disposed adjacent to a second channel in the holder body, the first channel and the second channel are formed in a circular shape to permit the pair of drumsticks to be slid into the first and second channels; and a center rib separating the first channel from the second channel, wherein the first channel and the second channel are operable to securely hold a pair of drumsticks therein.

These and other features, aspects and advantages of the present invention will become better understood with reference to the following drawings, description and claims.

### BRIEF DESCRIPTION OF THE DRAWINGS

FIG. 1 is a perspective view of a drumstick cradle holding a pair of drumsticks according to an exemplary embodiment of the present invention;

FIG. 2 is a perspective view of the drumstick cradle of FIG. 1 with one drumstick removed;

FIG. 3 is a perspective view of the drumstick cradle of FIG. 1;

FIG. 4 is a cross-sectional view taken along line 4-4 of FIG. 1;

FIG. 5 is a perspective view of a drumstick holder holding a pair of drumsticks according to an exemplary embodiment of the present invention;

FIG. 6 is a perspective view of the drumstick holder of FIG. 5 with one drumstick removed;

FIG. 7 is a perspective view of the drumstick cradle of FIG. 5;

FIG. 8 is a cross-sectional view taken along line 8-8 of FIG. 5;

FIG. 9 is a perspective view of a drumstick cradle with rounded corners, according to another exemplary embodiment of the present invention;

FIG. 10 is an end view of the drumstick cradle of FIG. 9;

FIG. 11 is a top view of the drumstick cradle of FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a two-channeled cradle that securely holds two drumsticks together to enhance organization and portability while preventing loss among other sticks. The cradle also prohibits drumsticks from rolling off a drum or any flat surface. The cradle can include two channels, side-by-side, formed in a C-shape with a diameter slightly less than that of the drumsticks, where the drumsticks can snap into the channels. In some embodiments, the cradle can be formed of two circular channels, where the drumsticks can be inserted into the channels. The cradle can have a flat bottom to help keep the cradle in place, without rolling or wobbling. By using the cradle, a drummer can reach into their stick bag and easily pull out a matched pair of drumsticks.

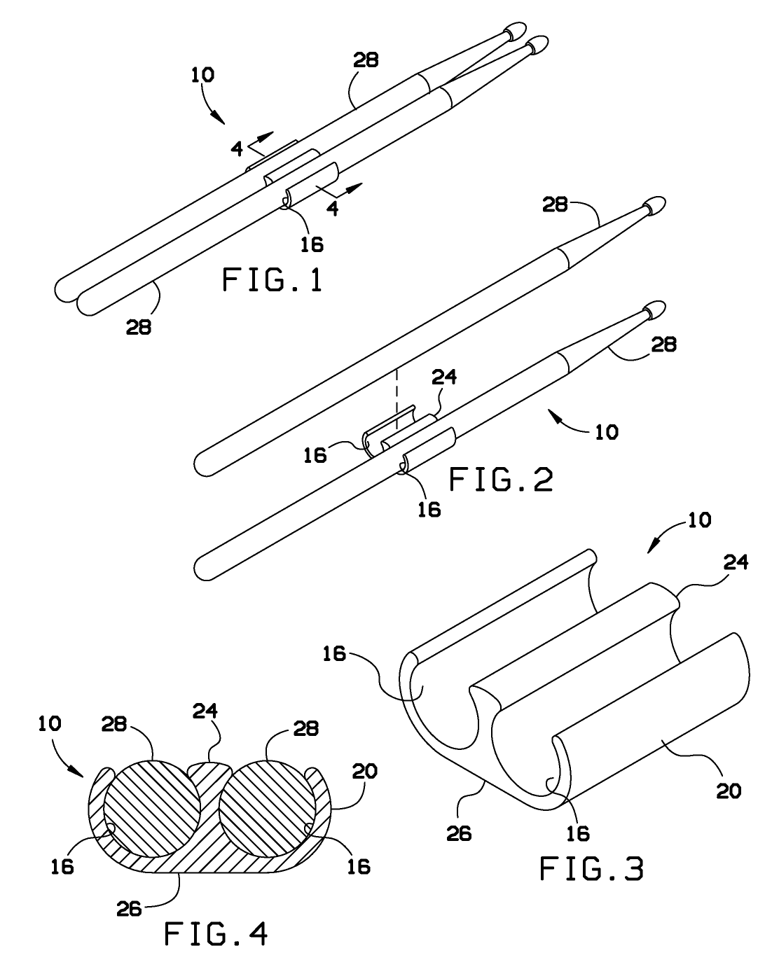

Referring to FIGS. 1 through 5, a drumstick cradle 10 includes a cradle body 20 and a center rib 24 forming two channels 16 disposed adjacent to each other. The drumstick cradle 10 can have a flat base 26 to help prevent rolling or wobbling of the drumstick cradle 10.

The channels 16 can be formed in a semi-circular shape, such as a C-shape, forming from about 200 to about 290 degrees of a circle, typically about 270 degrees of a circle (¾ of a circle).

Drumsticks 28 can be snapped into each channel 16, as shown in FIG. 1. In some embodiments, the drumstick cradle 10 can be made for one size drumstick, where the material of the drumstick cradle 10 is sufficiently rigid to permit the stick to press and snap into the channel 16. In other embodiments, the drumstick cradle 10 can be made for multiple sizes of drumsticks, where a flexible material can be used for the drumstick cradle 10 allowing the cradle body 20 to flex and support various diameters of drumsticks 28.

The materials for the drumstick cradle 10 can be, for example, plastic, vinyl, polymeric, composite or the like. Materials can be selected to allow the sticks to be inserted and slid in or out with ease and minimal friction.

The drumstick cradle 10 can be made in various colors to help identify different pairs of sticks. The length of the drumstick cradle 10 can vary from, for example, about 1 inch to about 5 inches, typically from about 1.5 inch to about 3 inches.

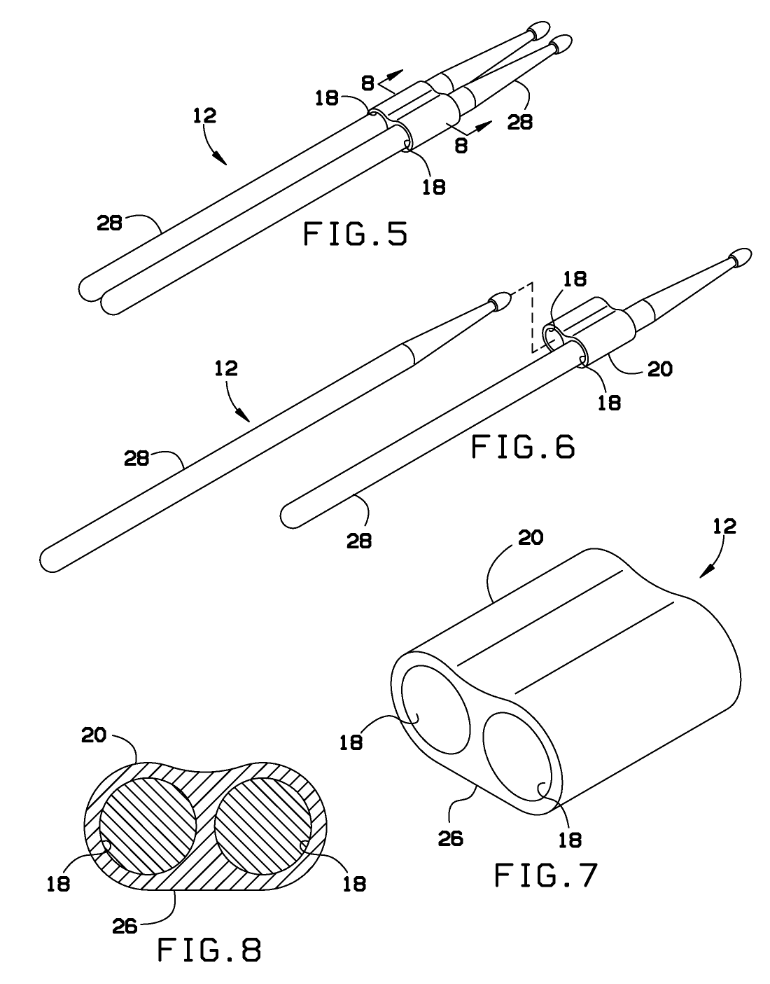

Referring now to FIGS. 5 through 8, a drumstick holder 12 can be designed with two enclosed circular channels 18 adjacent to each other in the cradle body 20. The channels 18 can be adapted to allow drumsticks 28 to slide into the channels 18, as shown in FIG. 6. Similar to the embodiment shown in FIGS. 1 through 4, the drumstick holder 12 can also include the flat base 26 to provide stability to the drumstick holder 12. The flat base 26 can be disposed on one side of the drumstick holder 12, as best seen in FIG. 8, or the drumstick holder 12 can be designed with the flat base 26 on both sides thereof.

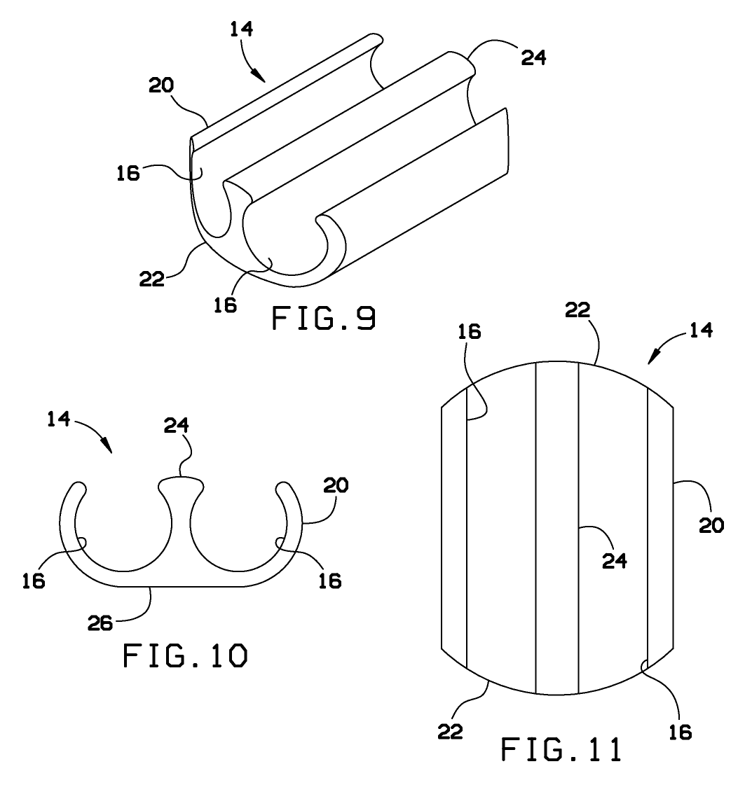

Referring now to FIGS. 9 through 11, the drumstick cradle 10 of FIGS. 1 through 4 can be modified to include rounded ends 22 to provide a rounded drumstick cradle 14. The rounded drumstick cradle 14 can otherwise be similar to the drumstick cradle 10 described above. While FIGS. 9 through 11 show a convex rounded drumstick cradle 14, other contours are included in the scope of the present invention. For example, a concave rounded drumstick cradle is contemplated within the scope of the present invention.

It should be understood, of course, that the foregoing relates to exemplary embodiments of the invention and that modifications may be made without departing from the spirit and scope of the invention as set forth in the following claims.

What is claimed is:

1. A drumstick cradle comprising:
a cradle body having a flat base;
a first channel disposed adjacent to a second channel in the cradle body; and
a center rib separating the first channel from the second channel, wherein
the first channel and the second channel are operable to securely hold a pair of drumsticks therein.

2. The drumstick cradle of claim 1, wherein the first channel and the second channel are formed in a semi-circular shape to permit the pair of drumsticks to be pressed into the first and second channels.

3. The drumstick cradle of claim 1, wherein the first channel and the second channel are formed in a circular shape to permit the pair of drumsticks to be slid into the first and second channels.

4. The drumstick cradle of claim 2, wherein the semi-circular shape extends about ¾ of a circle.

5. The drumstick cradle of claim 1, wherein the drumstick cradle is made from a rigid material adapted to secure a particular size of drumstick.

6. The drumstick cradle of claim 1, wherein the drumstick cradle is made of a flexible material adapted to secure multiple sizes of drumsticks.

7. The drumstick cradle of claim 1, wherein the cradle body has rounded ends.

8. A drumstick cradle comprising:
a cradle body having a flat base;
a first channel disposed adjacent to a second channel in the cradle body, the first channel and the second channel are formed in a semi-circular shape to permit the pair of drumsticks to be pressed into the first and second channels, the semi-circular shape extending about 200 to about 290 degrees of a full circle; and
a center rib separating the first channel from the second channel, wherein
the first channel and the second channel are operable to securely hold a pair of drumsticks therein.

9. The drumstick cradle of claim 1, wherein the cradle body has rounded ends.

10. A drumstick holder comprising:
a holder body having a flat base;
a first channel disposed adjacent to a second channel in the holder body, the first channel and the second channel are formed in a circular shape to permit the pair of drumsticks to be slid into the first and second channels; and
a center rib separating the first channel from the second channel, wherein
the first channel and the second channel are operable to securely hold a pair of drumsticks therein.
